(19) United States
(12) Patent Application Publication
(10) Pub. No.: US 2026/0004985 A1
(43) Pub. Date: Jan. 1, 2026

(54) CIRCUIT BREAKER AND METHOD FOR ASSEMBLING ARC EXTINGUISHING CHAMBER UNIT IN CIRCUIT BREAKER

(71) Applicant: FUJI ELECTRIC FA COMPONENTS & SYSTEMS CO., LTD., Konosu-city (JP)

(72) Inventor: Ryuichiro YAMAMURA, Konosu-shi (JP)

(73) Assignee: FUJI ELECTRIC FA COMPONENTS & SYSTEMS CO., LTD., Konosu-city (JP)

(21) Appl. No.: 19/060,233

(22) Filed: Feb. 21, 2025

(30) Foreign Application Priority Data
Jun. 28, 2024 (JP) 2024-104977

(51) Int. Cl. H01H 73/18; H01H 73/06

(52) U.S. Cl. CPC H01H 73/18; H01H 73/06

(57) ABSTRACT

A circuit breaker comprises a switching contact point configured by a fixed contact having a fixed contact point and a moving contact having a moving contact point, and an arc extinguishing chamber unit configured to extinguish an arc generated between the fixed contact point and the moving contact point. The switching contact point and the arc extinguishing chamber unit being arranged in a case. The arc extinguishing chamber unit includes a unit case and a plurality of grids arranged in layers in the unit case. The unit case includes a first case arranged near the switching contact point and configured to hold the plurality of grids and a second case configured to close an opening part of the first case and detachably coupled to the first case, and formed with an exhaust hole configured to exhaust arc gas to an outside.

### TECHNICAL FIELD

The present invention relates to a circuit breaker and a method for assembling an arc extinguishing chamber unit in a circuit breaker.

### BACKGROUND ART

A circuit breaker is arranged, in an arc extinguishing chamber in a case, with a switching contact point arranged by a fixed contact having a fixed contact point and a moving contact having a moving contact point and an arc extinguishing chamber unit extinguishing an arc generated between the fixed contact point and the moving contact point (e.g., Patent Document 1). The arc extinguishing chamber unit includes a unit case formed of a synthetic resin material and a plurality of grids arranged in layers inside the unit case. The unit case includes a pair of side walls arranged facing each other and enclosing the plurality of grids in a latitudinal direction and a rear wall enclosing one longitudinal end of the plurality of grids at a position distant from the fixed contact point and coupled to the pair of side walls, in which the rear wall is formed with an exhaust hole allowing the outside air and the inside of the arc extinguishing chamber unit to communicate with each other.

### CITATION LIST

### Patent Literature

Patent Document 1: JP 2008-186643 A

### SUMMARY OF INVENTION

### Technical Problem

In the conventional arc extinguishing chamber unit, the pair of side walls near the exhaust hole applies force to sandwich the plurality of grids in the latitudinal direction and holds the plurality of grids to be arranged in layers. Herein, the exhaust hole in the rear wall receives the flow of hot arc gas from an arc generated in the switching contact point at the time of break, and therefore there is a risk that a site where the grids are held of the pair of side walls near the exhaust hole is thermally damaged by the arc gas, so that the function of holding the grids is lost.

It is also conceivable that other components are incorporated in the unit case such that the function of holding the grids is not degraded by the thermal damage due to the arc gas. However, the unit case incorporated with other components has a risk that the unit case is difficult to assemble by automation of the arc extinguishing chamber unit.

Thus, it is an object of the present invention to provide a circuit breaker in which the function of holding the grids of the arc extinguishing chamber unit is not degraded by the arc gas generated at the time of break and a method for assembling an arc extinguishing chamber unit in a circuit breaker achieving automated assembly by an automatic machine.

### Solution to Problem

To achieve the above-described object, a circuit breaker according to one aspect of the present invention comprises: a switching contact point arranged by a fixed contact having a fixed contact point and a moving contact having a moving contact point; and an arc extinguishing chamber unit configured to extinguish an arc generated between the fixed contact point and the moving contact point, the switching contact point and the arc extinguishing chamber unit being arranged in a case, in which the arc extinguishing chamber unit includes a synthetic resin unit case and a plurality of grids arranged in layers in the unit case, and the unit case includes a first case arranged near the switching contact point and configured to hold the plurality of grids and a second case configured to close an opening part of the first case and detachably coupled to the first case, and formed with an exhaust hole configured to exhaust arc gas to the outside.

A method for assembling an arc extinguishing chamber unit adapted for a circuit breaker according to one aspect of the present invention is a method for assembling an arc extinguishing chamber unit arranged in a circuit breaker, the arc extinguishing chamber unit including a first case where a plurality of grids is held in layers inside the case and a rear side of the plurality of grids projects from an opening part and a second case configured to close the opening part of the first case and coupled to the first case, and the second case being formed with clamping ribs capable of clamping the rear sides of the grids, and the method includes: supporting the first case such that the plurality of grids faces upward; and lowering the second case to the side of the first case such that the clamping ribs clamp the rear sides of the grids.

### Advantageous Effects of Invention

The circuit breaker according to the present invention can maintain the function of holding the grids of the arc extinguishing chamber unit over a long period of time.

The method for assembling an arc extinguishing chamber unit adapted for a circuit breaker according to the present invention achieves automated assembly of the arc extinguishing chamber unit by an automatic machine.

### BRIEF DESCRIPTION OF DRAWINGS

FIG. 1 is a cross-sectional view illustrating a circuit breaker according to the present invention.

FIG. 2 is a perspective view illustrating an arc extinguishing chamber unit according to the present invention.

FIGS. 3A and 3B are views illustrating a first case constituting the arc extinguishing chamber unit.

FIG. 4 is a perspective view illustrating a state before a second case is assembled to the first case where grids constituting the arc extinguishing chamber unit are arranged.

FIG. 5 is a cross-sectional view illustrating the inside of the arc extinguishing chamber unit.

FIG. 6 is a cross-sectional view of a principal part illustrating the inside of the arc extinguishing chamber unit.

FIG. 7 is a cross-sectional view of a circuit breaker illustrating a state at the time of a current-limiting opening operation of a moving contact.

FIG. 8 is a view illustrating a state before the second case is coupled to the first case in a method for assembling an arc extinguishing chamber unit.

FIG. 9 is a view illustrating a state in which the second case has been coupled to the first case in the method for assembling an arc extinguishing chamber unit.

### DESCRIPTION OF EMBODIMENT

Next, an embodiment according to the present invention is described with reference to the drawings. In the description of the drawings below, the same or similar reference signs are attached to the same or similar parts. It should be noted that the drawings are schematic, and the relation between the thickness and the plane dimension, the thickness ratio of each layer, and the like are different from the actual relation, ratio, and the like. Therefore, the specific thickness and dimension should be determined in consideration of the description below. It is a matter of course that the drawings may include portions different in mutual dimensional relations and ratios.

The embodiment described below exemplifies devices or methods for embodying the technical idea of the present invention. The technical idea of the present invention does not specify the materials, shapes, structures, arrangement, and the like of constituent components to the materials, shapes, structures, arrangement, and the like described below. The technical idea of the present invention can be variously altered within the technical scope defined by the claims.

The terms indicating directions, such as “upper”, “lower”, “left”, “right”, “bottom”, “front”, “rear”, “longitudinal direction”, and “latitudinal direction”, described in the description below are used with reference to the directions in the accompanying drawings.

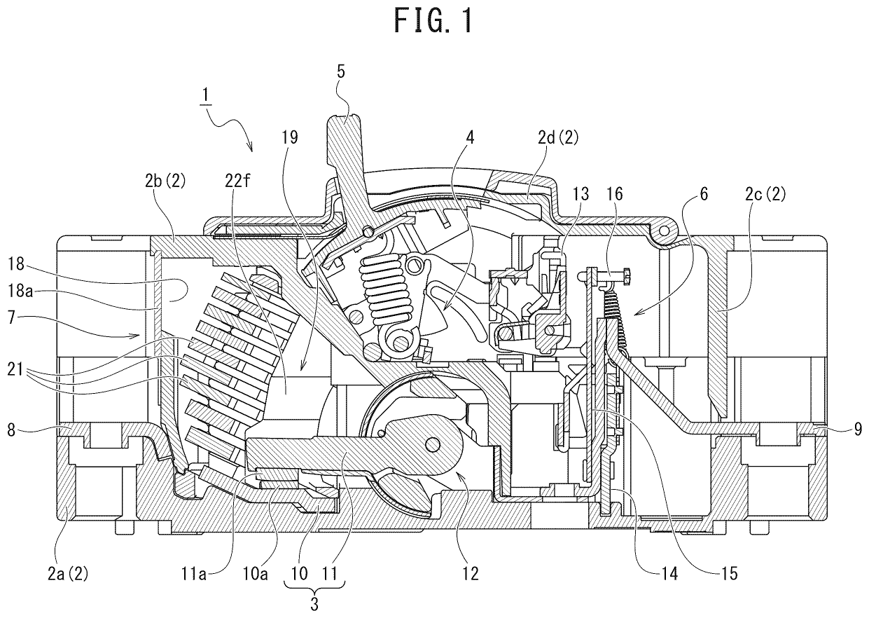

FIG. 1 is a cross-sectional view illustrating a mechanical molded case circuit breaker (hereinafter referred to as a circuit breaker) 1 of a first embodiment for three-phase (R, S, and T phases) alternating current connected between the power supply side and the load side of a circuit, and illustrates the circuit structure of one of the phases incorporated in parallel in a main case 2.

In the circuit breaker 1, a switching mechanism 4 switching a switching contact point 3, a switching handle 5 operating the switching mechanism 4, an overcurrent tripping device 6 causing the switching mechanism 4 to perform a tripping operation when an overcurrent flows through a main circuit, and an arc extinguishing chamber unit 7 are arranged inside the main case 2.

The main case 2 is configured such that a power-supply-side intermediate case 2b and a load-side intermediate case 2c are assembled in an overlapped manner to a lower case 2a and a top cover 2d is assembled in an overlapped manner to the power-supply-side intermediate case 2b and the load-side intermediate case 2c. To the lower case 2a, a power-supply-side main circuit terminal 8 and a load-side main circuit terminal 9 are fixed.

The switching contact point 3 includes a fixed contact 10 having a fixed contact point 10a and a moving contact 11 having a moving contact point 11a, and the moving contact 11 is rotatably supported by a holder unit 12. The fixed contact 10 is connected to the power-supply-side main circuit terminal 8. The moving contact 11 is connected to the load-side main circuit terminal 9 via the holder unit 12 and the overcurrent tripping device 6.

The switching mechanism 4 includes a latch mechanism obtained by combining a toggle link mechanism (not illustrated) linking the moving contact 11 and the switching handle 5, a latch (not illustrated), and a trip crossbar 13. When the trip crossbar 13 turns counterclockwise, the moving contact 11 performs an opening operation by a tripping operation of the switching mechanism 4.

The overcurrent tripping device 6 includes a heater 14 performing heating when an overcurrent flows between the power-supply-side main circuit terminal 8 and the load-side main circuit terminal 9, a bimetal 15 fixed to a lower part of the heater 14, and an adjusting screw 16 engaged with the free end of an upper part of the bimetal 15 and made movable forward and backward to provide a predetermined gap between the adjusting screw 16 and the trip crossbar 13.

In the lower case 2a and the power-supply-side intermediate case 2b of the main case 2, an arc extinguishing chamber 19 is formed which houses the switching contact point 3, the holder unit 12, and the arc extinguishing chamber unit 7. The arc extinguishing chamber unit 7 includes a plurality of grids 21 arranged in layers and an exhaust hole 18 communicating with the outside on the side of an end part separated from the switching contact point 3 of the plurality of grids 21, and the exhaust hole 18 is covered with a protective plate 18a.

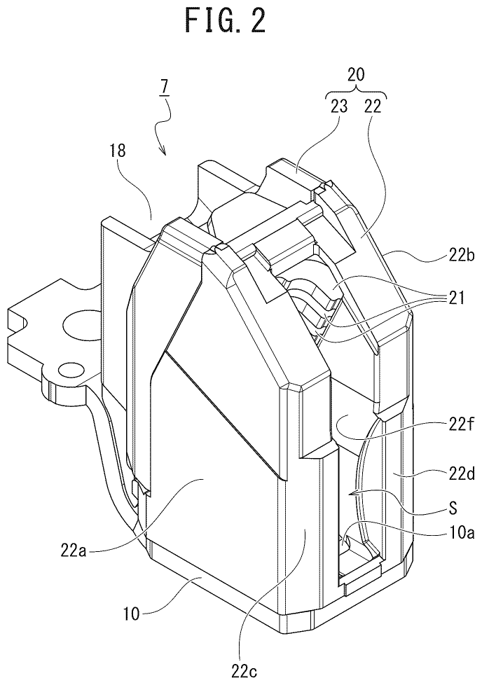

The arc extinguishing chamber unit 7 includes a synthetic resin unit case 20 and the plurality of grids 21 formed of iron arranged in layers inside the unit case 20 as illustrated in FIG. 2. The unit case 20 includes a first case 22 and a second case 23 arranged in an upper part of the fixed contact 10 with the fixed contact point 10a interposed therebetween.

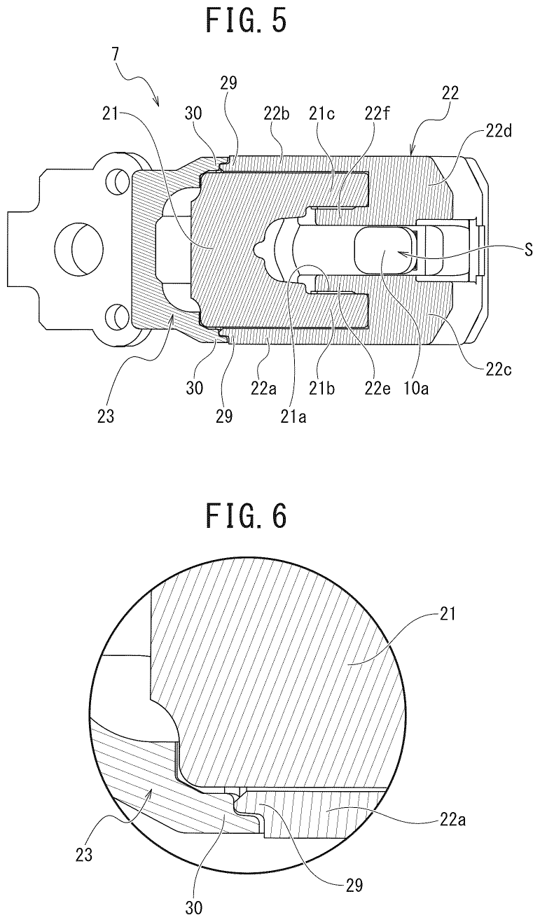

The first case 22 is a casing opened on the side facing the second case 23 as illustrated in FIGS. 2 and 5, and includes a pair of first outer walls 22a, 22b formed parallel to each other, second outer walls 22c, 22d formed orthogonally to the first outer walls 22a, 22b, respectively, and a pair of inner walls 22e, 22f formed extending parallel to the first outer walls 22a, 22b from the second outer walls 22c, 22d, respectively. Space designated by the reference sign S between the pair of inner walls 22e, 22f is movement space of the moving contact 11 where the moving contact point 11a contacts/separates from the fixed contact point 10a.

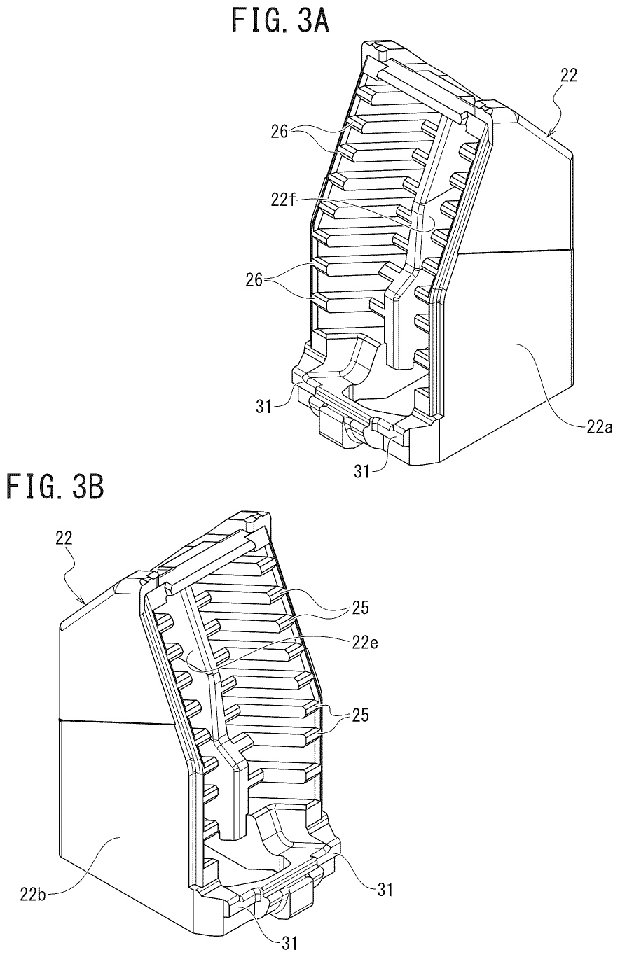

As illustrated in FIGS. 3A, 3B, a plurality of first ribs 25 is formed in a projecting manner at predetermined intervals in the vertical direction among the first outer wall 22a, the second outer wall 22c, and the inner wall 22e. A plurality of second ribs 26 is also formed in a projecting manner at predetermined intervals in the vertical direction among the first outer wall 22b, the second outer wall 22d, and the inner wall 22f. By placing the grids 21 on the upper surfaces of the first ribs 25 and the second ribs 26, the plurality of grids 21 is arranged in a stacked state.

As illustrated in FIG. 5, the grid 21 has a slit 21a in the center and has a pair of leg parts 21b, 21c extending in the longitudinal direction on both sides of the slit 21a. One leg part 21b of the grid 21 is press-fitted between the first outer wall 22a and the inner wall 22e to be sandwiched and held in the latitudinal direction between the first outer wall 22a and the inner wall 22e. The other leg part 21c of the grid 21 is also press-fitted between the first outer wall 22b and the inner wall 22f to be sandwiched and held in the latitudinal direction between the first outer wall 22b and the inner wall 22f. Thus, the plurality of grids 21 in this embodiment is sandwiched and held in the latitudinal direction between the inner walls 22e, 22f and the first outer walls 22a, 22b, respectively, arranged near the switching contact point 3.

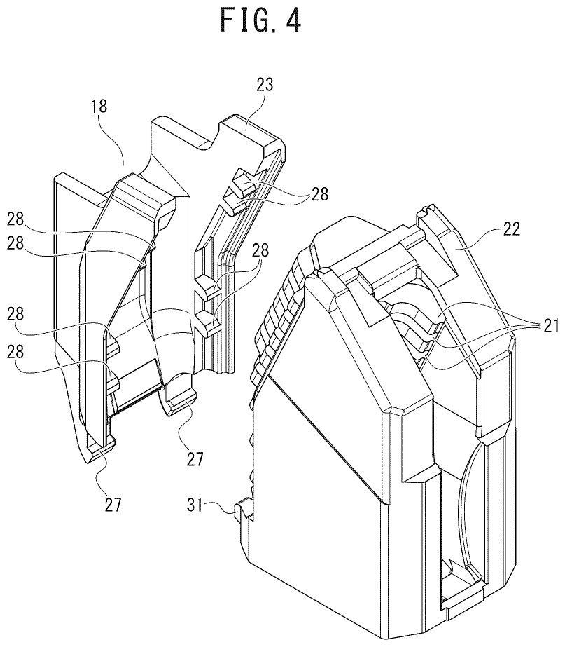

The second case 23 is a lid member closing an opening part of the first case 22 and has the exhaust hole 18 formed in an upper part as illustrated in FIG. 4. The second case 23 has anti-fall hooks 27 formed in a lower part. The anti-fall hooks 27 are configured to be engaged with engaging projection parts 31 provided on the lower side of the opening part of the first case 22 illustrated in FIG. 4 when the second case 23 has closed the opening part of the first case 22 and has been coupled to the first case 22. Engagement means described in the present invention are equivalent to the anti-fall hooks 27 and the engaging projection parts 31.

As illustrated in FIG. 4, the second case 23 is formed with a plurality of pairs of clamping ribs 28 on the inner wall. These clamping ribs 28 are configured to sandwich end parts of the predetermined grids 21 projecting from the opening part of the first case 22 when the opening part of the first case 22 has been closed by the second case 23.

As illustrated in FIG. 6, the first case 22 is formed with a first case engagement part 29 having an irregular shape continuously extending in the longitudinal direction in an end part on the side of the opening part of the first outer wall 22a. The second case 23 to be engaged with the first outer wall 22a is also formed with a second case engagement part 30 having an irregular shape continuously extending in the longitudinal direction. As illustrated in FIG. 5, the first case 22 is also formed with the first case engagement part 29 in an end part on the side of the opening part of the first outer wall 22b and the second case 23 to be engaged with the first outer wall 22b is also formed with the second case engagement part 30 having an irregular shape continuously extending in the longitudinal direction. It is configured such that projection parts of the second case engagement part 30 are fitted into recess parts of the first case engagement part 29 and recess parts of the second case engagement part 30 are fitted into projection parts of the first case engagement part 29, and thus the second case 23 is coupled to the first case 22 in a state of closing the opening part of the first case 22.

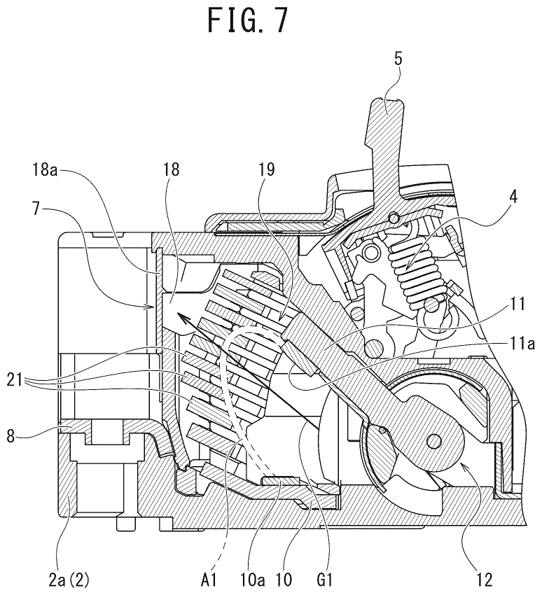

FIG. 7 illustrates a current-limiting opening operation of the moving contact 11 when an overcurrent flows between the power-supply-side main circuit terminal 8 and the load-side main circuit terminal 9 of the circuit breaker 1. Arc gas flows from an arc A1 generated in the switching contact point 3 toward the exhaust hole 18, so that the arc extinguishing chamber 19 near the exhaust hole 18 is exposed to the hot arc gas. The arc extinguishing chamber unit 7 in this embodiment has no risk of being thermally damaged by the hot arc gas near the exhaust hole 18 because the pair of leg parts 21b, 21c of the plurality of grids 21 is sandwiched and held in the latitudinal direction between the inner walls 22e, 22f and the first outer walls 22a, 22b, respectively, of the first case 22 arranged near the switching contact point 3. Thus, even when the arc gas flows near the exhaust hole 18, the plurality of grids 21 can be held over a long period of time without being thermally damaged and the grids 21 can be prevented from falling down to the switching contact point 3, reducing risks of a conduction failure and a switching operation failure of the circuit breaker 1.

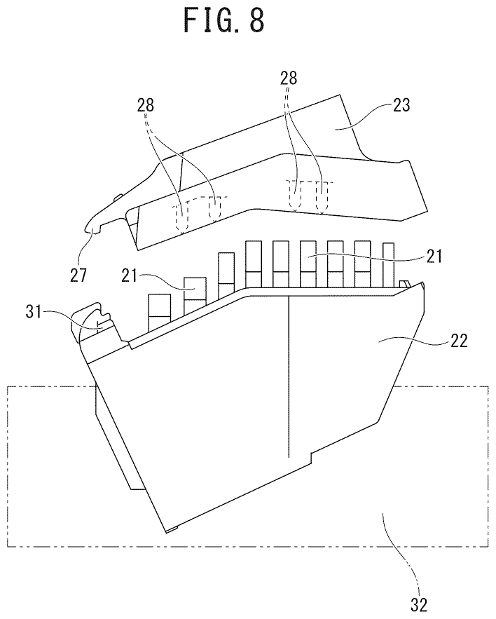

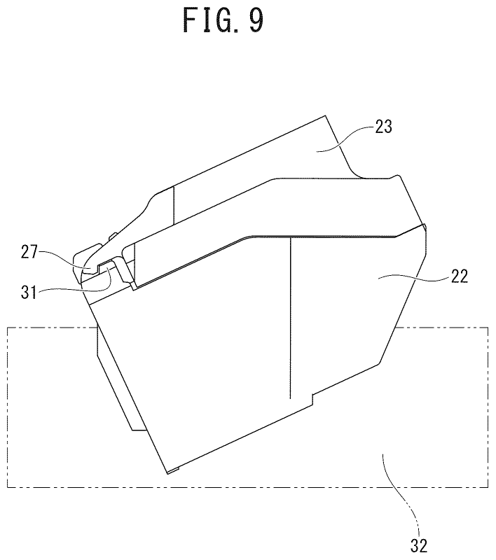

Next, a method for attaching the second case 23 to the first case 22 attached with the plurality of grids 21 is described with reference to FIGS. 8 and 9.

First, the first case 22 is supported by a channel base 32 such that the plurality of grids 21 attached to the first case 22 faces upward as illustrated in FIG. 8.

Subsequently, the second case 23 is lowered downward to close the opening part of the first case 22, so that the clamping ribs 28 provided in the second case 23 sandwich the end parts of the predetermined grids 21 of the first case 22.

Subsequently, the second case 23 is further lowered downward, so that the first case engagement parts 29 of the first case 22 and the second case engagement parts 30 of the second case 23 are coupled to each other and the anti-fall hooks 27 provided in the second case 23 are engaged with the engaging projection parts 31 provided in the first case 22.

Thus, the second case 23 sandwiches end parts on the rear side of the predetermined grids 21 and is coupled to the first case 22 in the state of closing the opening part of the first case 22 while the second case 23 is prevented from falling down by the engagement of the anti-fall hooks 27 and the engaging projection parts 31.

According to the method for attaching the second case 23 to the first case 22 attached with the plurality of grids 21 in this embodiment, the second case 23 can be attached to the first case 22 by simply lowering the second case 23 downward to the first case 22 arranged such that the plurality of grids 21 faces upward, and therefore coupling work of the second case 23 to the first case 22 attached with the grid 21 can be performed by automated assembly by an automatic machine.

### REFERENCE SIGNS LIST

1: mechanical molded case circuit breaker (circuit breaker)
2: main case
2a: lower case
2b: power-supply-side intermediate case
2c: load-side intermediate case
2d: top cover
3: switching contact point
4: switching mechanism
5: switching handle
6: overcurrent tripping device
7: arc extinguishing chamber unit
8: power-supply-side main circuit terminal
9: load-side main circuit terminal
10: fixed contact
10a: fixed contact point
11: moving contact
11a: moving contact point
12: holder unit
13: trip crossbar
14: heater
15: bimetal
16: adjusting screw
18: exhaust hole
18a: protective plate
19: arc extinguishing chamber
20: unit case
21: grid
21a: slit
21b, 21c: pair of leg parts
22: first case
22a, 22b: first outer wall
22c, 22d: second outer wall
22e, 22f: inner wall
23: second case
25: first rib
26: second rib
27: anti-fall hook
28: clamping rib
29: first case engagement part
30: second case engagement part
31: engaging projection part
32: channel base
S: moving contact movement space

1. A circuit breaker comprising:
a switching contact point arranged by a fixed contact having a fixed contact point and a moving contact having a moving contact point; and
an arc extinguishing chamber unit configured to extinguish an arc generated between the fixed contact point and the moving contact point,
the switching contact point and the arc extinguishing chamber unit being arranged in a case, wherein
the arc extinguishing chamber unit includes a unit case and a plurality of grids arranged in layers in the unit case, and
the unit case includes a first case arranged near the switching contact point and configured to hold the plurality of grids and a second case configured to close an opening part of the first case and detachably coupled to the first case, and formed with an exhaust hole configured to exhaust arc gas to an outside.

2. The circuit breaker according to claim 1, wherein
the first case includes a pair of inner walls arranged facing each other and forming movement space of the moving contact and a pair of outer walls arranged facing each other on an outside of the pair of inner walls, and
the grid has a pair of leg parts extending in a longitudinal direction with a slit interposed between the pair of leg parts, each of the pair of leg parts being sandwiched and held in a latitudinal direction between one and another one of the inner walls and one and another one of the outer walls, respectively, of the first case.

3. The circuit breaker according to claim 1, wherein
an end part on a rear side of the plurality of grids projects from the opening part of the first case, and
the second case includes clamping ribs configured to clamp the rear sides of predetermined grids among the plurality of grids when the second case has closed the opening part of the first case.

4. The circuit breaker according to claim 1 comprising:
engagement means configured to prevent the first case from falling down when the second case has been coupled to the first case.

5. A method for assembling an arc extinguishing chamber unit adapted for a circuit breaker,
the arc extinguishing chamber unit including a first case where a plurality of grids is held in layers inside the case and a rear side of the plurality of grids projects from an opening part and a second case configured to close the opening part of the first case and coupled to the first case, and
the second case being formed with clamping ribs capable of clamping the rear sides of the grids, and
the method comprising:
supporting the first case such that the plurality of grids faces upward; and
lowering the second case to a side of the first case such that the clamping ribs clamp the rear sides of the grids.

6. The method for assembling an arc extinguishing chamber unit adapted for a circuit breaker according to claim 5, wherein
the second case is formed with an anti-fall hook,
the first case is formed with an engaging projection part to be engaged with the anti-fall hook, and
in the lowering of the second case to the side of the first case, the anti-fall hook and the engaging projection part are engaged with each other.
